(19) United States
(12) Patent Application Publication
(10) Pub. No.: US 2014/0100888 A1
(43) Pub. Date: Apr. 10, 2014

(54) Method to Identify Potential Workers Compensation Customers and Mapping Their Location

(71) Applicants: Derek Wirz, Ooltewah, TN (US); Kevin S. Hale, Joelton, TN (US)

(72) Inventors: Derek Wirz, Ooltewah, TN (US); Kevin S. Hale, Joelton, TN (US)

(21) Appl. No.: 13/644,985

(22) Filed: Oct. 4, 2012

(51) Int. Cl. G06Q 40/08

(52) U.S. Cl. 705/4

(57) ABSTRACT

A system and method of acquiring from databases, potential customers that an insurance producer or software subscriber (user) desires to sell workers compensation insurance, utilizing their potential customers address(es), the potential customers insurance company(ies) names (past and present), their pricing basis, and other information such as industry type(s), classification(s) and rating information. The system also compares user's pricing levels from user's insurance companies with the current/expiring insurance that a potential customer may have. The system also coordinates the said address(es) with a mapping database or global positioning system (GPS) to assist the user in locating the potential customers as well as allowing the producer's office to track each visit. The system also integrates the said information into a workers compensation insurance application and request for loss runs from current and previous insurance carriers of potential customers so that the insurance carriers of user may consider the risk of potential customers.

### CLAIM OF PRIORITY

This application claims the benefit of U.S. Provisional Patent Application No. 61/543,063 filed Oct. 4, 2011 which is incorporated herein in its entirety by reference.

### FIELD OF INVENTION

The present invention pertains to a method for a computer software, Internet software, or other software such as a Web application to access information from data sources, such as databases that house information which identify what businesses have workers compensation insurance, effective date of coverage, expiration date of coverage (the date that coverage is expiring or thought to expire), insurance carrier name or program, premium charges or methods to charge the policyholder for the premium or loss cost multiplier (LCM) and then reporting back to a software subscriber (subscriber) or their authorized user (often an insurance producer, agent, or broker) the results of the search. The system and method also compares the premium charges or loss costs and the loss cost multipliers (LCM) of the current, expiring or expired policyholder's carriers to offerings that a software subscriber may be able to offer with insurance carriers that the insurance producer may represent or may broker for, or have access to. The system and method also cooperates with mapping software and/or global positioning systems or devices (GPS) to notify software subscriber to direct them to the location or effectively plan a trip as well as reporting the vehicle locations that the producer uses to call on the prospects and reporting back the producer's headquarters or sales manager so that all parties may monitor progress of each visit from the leads produced through the software or allowing producers headquarters to track in real-time or thereafter after the location of the producer (with the leads given or assimilated through said system). The system may also assist the software subscriber with completing information on an application for a workers compensation quote or policy, assimilating letters requesting loss history reports or loss runs from current and expired carriers, assimilating agent of record letters or broker of record letters, assimilating letters or requests to obtain information from carriers or rating bureaus such as NCCI or other authority, etc. Once these documents are assimilated, an electronic signature or manual signature may be imported or exported into the process and sent to the proper parties. The system may also report the progress of each lead and contact into a traditional customer relationship management program (CRM), policy administration system (PAS) or agency management system (AMS).

### DESCRIPTION OF PRIOR ART

In the past insurance producers solicited prospects for workers compensation insurance policies by contacting potential buyers of insurance from leads that are either purchased or secured from a third party, secured own their own, referred by another party, mining the information from certificates of insurance, new businesses starting up, current books of business, email, mail, visits, phone inquiries, or from data sources such as the state workers compensation authorities, state industrial relations boards, state labor boards, a workers compensation authority such as the National Council on Compensation Insurance (NCCI), Insurance Service Office (ISO), an assigned risk administrator, or “coverage verification services.”

Companies such as WorkCompLeads.com, Datalister.com or Risk Metrics operate companies that sells software packages that repackage or expose to a software subscriber data (often times insurance producers) that they acquire from sources such as the coverage verification services or other databases. These services in-effect allow these software subscribers to monitor expiration dates of workers compensation policies or policyholders and allow these software subscribers to search from queries that are controlled by their software subscriber. These systems stop short of the functionality of the embodiment described in this patent application in that it does not compare the rates or loss cost multipliers (LCM) or “values” of a prospective policyholder's current or expiring insurance carrier to the offerings that may be available through a software subscriber's insurance companies or brokerage facilities. Additionally, this prior art software/process does not allow the insurance producer to expose the current or expired insurance carriers, rate information or loss cost multipliers (LCM) for purposes of identifying these opportunities to reduce the cost of workers compensation or the automated assistance of transferring the information into a mapping software to specifically reveal to the user the immediate opportunities while driving or walking near these businesses that maintain workers compensation insurance so that their software subscriber or user may easily locate these prospective customers. Additionally, this prior art fails to transfer the information obtained from the data feed to assist in the population of an insurance application for quote or policy issuance. Additionally, these systems have old or unreliable information because these systems often have not been updated, or may not be updated frequently, and or only updated on a periodic basis, which may not be acceptable to the end user because the information may change as businesses renew, change insurance carriers, or cancel their insurance coverage altogether, etc.

Certainly there are many methods for vehicles that have tracking systems and methods of receiving and transferring information from field sales staff and delivery staff such as trucking companies and others. Additionally, there are systems that allow a person to locate prospects or businesses that may be targeted for representative to call on. We recognize the value of these systems and the purpose of these systems. These systems however stop short of methods of receiving and transferring data and exchange of information for field insurance sales people (producers) back to headquarters or agency, especially methods of transferring data into GPS systems or other mapping software and then assimilating applications and the other necessary data for an insurance company to consider an application for workers compensation. There have been attempts with customer relationship management software (CRM) to “map” prospects in the insurance industry. We cite a company called “Vertafore” with a program called “Pipeline Manager.” Specifically, their programs stop short of exposing the data of current and past carriers, their LCMs or pricing, comparing what the producer may have to offer through their sources, preparing applications or ACORD applications for workers compensation from the data, as well as requesting the loss runs requests from expired or current insurance carriers, assimilating broker of records letters, or requesting that the producer be allowed access to certain data such as Experience Modifications, or obtaining electronic signatures on a computer device such as an Ipad™, etc.

Additionally, the business process as referenced in the patent application titled “Automated Insurance Verification System” U.S. patent application Ser. Nos. 13/111,104 and 61/543,063 incorporated by reference in its entirety receives the same data set and converts the data into a system that monitors whether a specific policyholder is covered with a workers compensation policy or not. This process is patent pending by the same inventors.

### SUMMARY OF INVENTION

The subject of this patent application is a software program and business process that would primarily, but not exclusively, be associated with how information about a prospective workers compensation customer would be released to a subscriber (many times an insurance producer) through a Database of Information, as at step #1.

In the free-market environment of the insurance industry, competition has been extraordinary in that insurance producers make their living off of a commission or fee. Many times the insurance producer has to bring something of “value” to the consumer (the business) to be awarded the insurance business and in this software program the comparison “values” of one insurance company to another and their offerings may be available. Often the “value” may be a better price, premium payment terms, better coverage, broader scope of territory or states covered, better policyholder services (customer service), industry expertise, dividend programs that determine return premiums paid on a loss ratio basis or other basis, loss control services, risk management programs, an array of deductible offerings, locality of the agency, brand recognition, insurance carrier market reputation, insurance carrier financial strength, financial ratings such as A. M. Best®, association endorsements, and others.

Many insurance agents have marketing systems that allow them to grow their books of business and this software system and method allows the producer to identify prospective customers easier than in the past. Additionally, the software may allow sales management of an insurance agency or brokerage to track each account that the insurance producer is located during the course of the working day and assist the producer where needed. This tool will assist the sales management team to hold each producer accountable for their time and resources, as at step #2.

The method of how an insurance producer develops a book of business is most often identifying those businesses that they would like to work with, communicating to those business (decision makers) that they wish to work on their insurance, developing information about the business such as prior policy information and policy loss history, then possibly quoting their insurance, and when successful writing their insurance. In the embodiment of this patent, we describe the method of how the software assists the insurance producer solidifies this process in converting those prospects into customers or policyholders. Many times, the decision hinges on which policy to purchase based on the premium quotations and it is the producer's job to deliver the policies and price (premium) that the policyholder deserves or pricing believed to be appropriate for one of many factors as determined by the producer and/or other party such as an underwriter. This software assists the insurance producer in finding those prospective customers and possibly insuring those businesses that their insurance companies can offer products to, as at step #1, 2, 3, 4, and 5.

The overhead expenses of using the prior art has been expensive to the producer and to the agencies or brokerages that they represent. Those expenses include the administrative and marketing support, fuel and automotive expenses in finding these prospects, the time needed to develop a premium quotation or compare expiring/renewing insurance company offerings to offerings of the insurance producer, and other associated costs of customer acquisition. Especially since no company has commercially made available the LCMs of every policy written and the location of the policyholder. The time spent contacting these prospects under the prior art is also cumbersome as compared to the present invention, as at step #1, 2, 3, 4, and 5.

Because the information (Database of Information) of what businesses are covered with workers compensation is commercially available from state sources or other sources, the inventors wish to present in this patent application an improved delivery of this information which includes what businesses have workers compensation, their address, NAICS or SIC codes (industry codes), number of employees, insurance company name, the insurance company federal identification number, effective date and expiration date of insurance, policy number, workers compensation governing classifications, payroll information, the number of employees, phone numbers, contact name, and other information which may include characteristics of the prospective policyholder. Additionally, in some cases the prior carrier's (expired) names and policy numbers (as opposed to expiring carrier or current carrier). This information is important so that the user may assimilate applications or export the found information into an application such as an ACORD or export into an insurance company rating engine or underwriting system, as at step #1 and 4.

The flaw of the database(s) that are referenced in the prior art is that they do not compare the rates or LCMs of both the expiring policies of these prospects and the rates and LCMs of the insurance producer using this software. The present invention properly notifies the user (often the insurance producer) information about the relevant pricing that they need to compete, as at step #3.

The prospect (the business with expiring insurance) may have a portal themselves to develop information and flag the insurance industry and software subscribers that they desire quotations and expose this information to a certain insurance producer, insurance company or on a indiscriminate basis. This will require a portal to allow the insurance information from the prior years to be exposed and they then answer questions that will allow the loss runs and other information to be released or at least requested. In other words, the customer may have the same tools that the insurance producer may have so that they may manage their own insurance renewal and control the entire process. When this occurs, the agent may be flagged on the GPS system or other method such as an email, social media, fax, or other method of communicating that the policyholder (prospect) has the data and desires a visit or call, for the insurance producer to pick up the information populated by the policyholder, etc, as at step #1, 2, 3, 4, and 5 and 5b.

The insurance producer may use the software to give marketing instructions to the support staff person at the agency or brokerage. This may entail exposing the applications and signed documents to the staff person to follow up and process the quote request, etc, as at step #1, 2, 3, 4, and 5 and 5a.

### BRIEF DESCRIPTION OF THE DRAWINGS

The particular features and advantages of the invention as well as other objects will become apparent from the following description taken in connection with the accompanying drawings in which a user may input information and receive information.

FIG. 1 is a diagrammatic representation of a system using the method of the preferred embodiment of the present invention; and

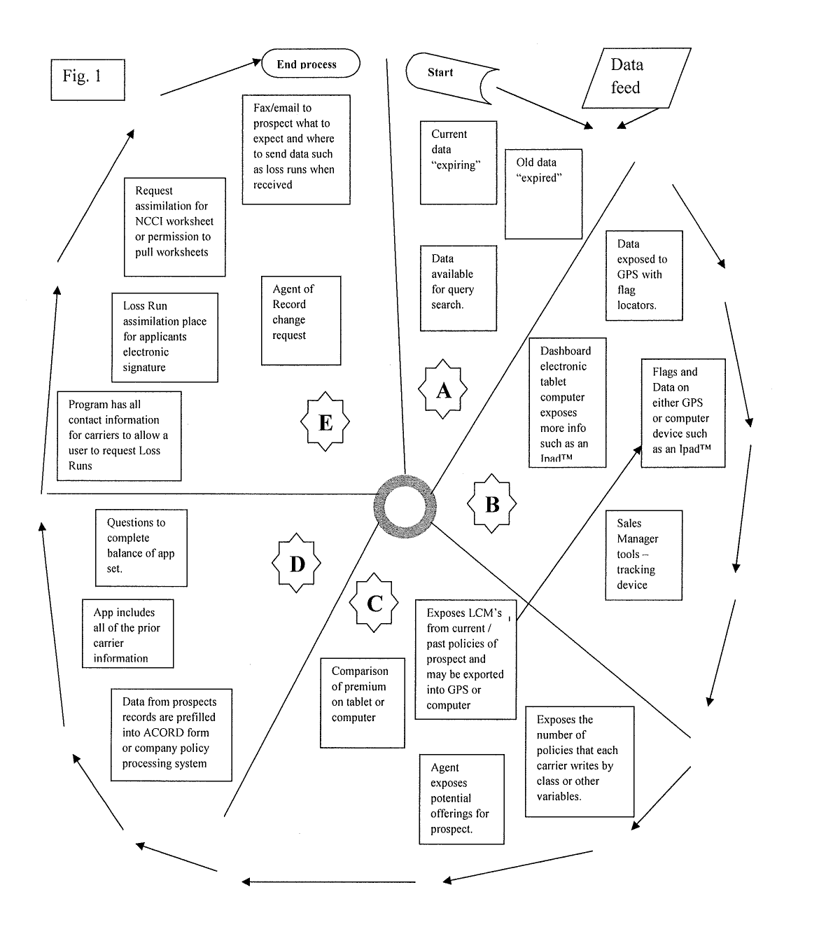

FIG. 2 is a flowchart showing the system of FIG. 1.

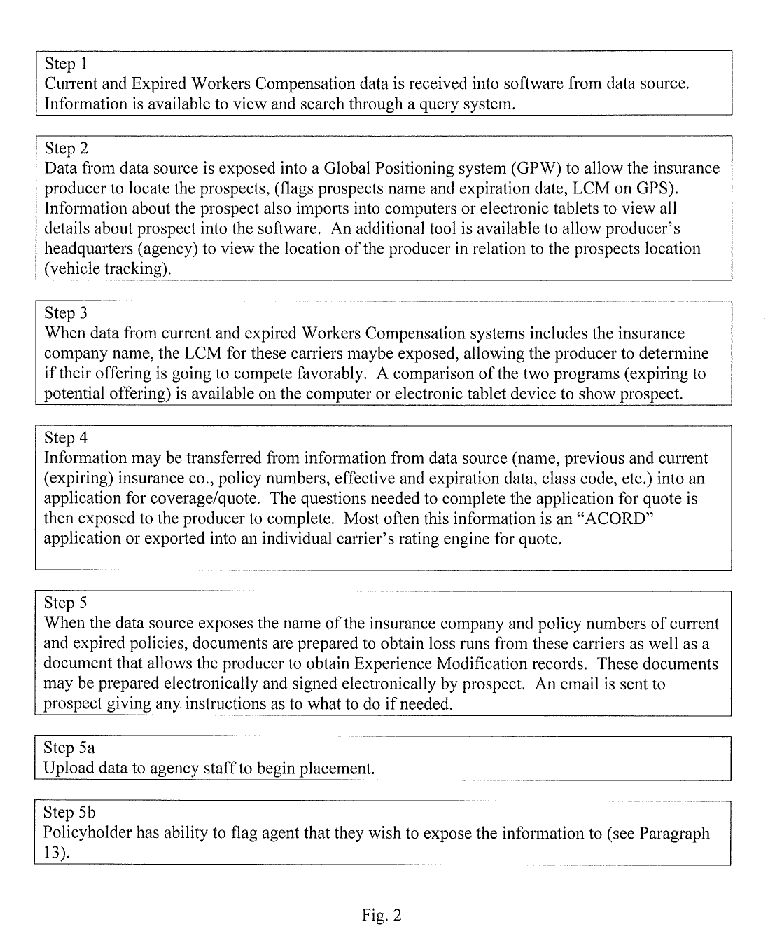

### DETAILED DESCRIPTION OF THE PREFERRED EMBODIMENT

The process involves:

Database becomes available from a source such as Coverage Verification Services: This method entails where this Database of Information comes from, is often in real-time, or as close to real-time that is commercially available or necessary. This data is formatted into the software, or is coordinated with the software so that the database may be integrated within the software—or is searchable. Database includes the carrier name, policy number, policy effective date, policy expiration date current and prior year policy information. Database is available for query through a flat file or other method of formatting such as spreadsheet. For example, if the user needed to look up all prospective customers that were in a particular zip code and coverage that just went into effect that had an LCM of greater than 1.50, the software may support such a query, as at step 1.

Information is integrated into a Global Positioning System (GPS) system and each location within the database is flagged and other information (carrier, LCM, other). Information about the progress of the producer's sales efforts and the location of the “where-abouts” are available to the sales manager or appointed representative at the producer's office (location tracking device). This analytical tool box reveals where each producer stopped, mapping the direction and reveals the results through a report called the “Sales Manager's Toolbox,” as at step 2.

Information is integrated into a computer system, laptop, computer tablet, smart phone system or other computing device and each location within the database is flagged and other information may be exposed which may include manually input data about the prospect or other data that is included in the data feed from the source at step 1 above. In fact the data may include LCM (pricing) which will allow the producer to be mobile and collect data such as what is described below or be able to compare what the prospect is paying to what the producer may have available (as at step 3). Additionally, this information may include analytics that exploits how many policies that the carrier that insures the prospective customer may have for the specific class of business which may indicate some competitive intelligence, etc. This may include a “dashboard” of information and gauges. The information may be exposed as “bubbles” or in a flat file format, interfaces, or other graphic user interfaces, etc, as at step 2 and 3. The computer device, electronic tablet computer or GPS may illustrate Table 1, such as from a GPS or Electronic Tablet illustrated (i.e., an example of “bubble”) as follows:

TABLE 1

Named Insured: ABC Company, LLC
Address: 123 Main St. Anytown, ST 12345
Owners Name: John Doe
Phone Number: (555) 892-8139
SIC Code: 5555
Industry Types: widgets
Primary Classification: 5555
Payroll: $75,000
Current Carrier: ABC Mutual Insurance Co
LCM: 1.49
Effective Date of Coverage: 01/01/2011
Date of Expiration: 01/01/2012

Information regarding current (the expiring policy) and proposed policies is integrated into a computer system, specifically the prospects insurance carrier's LCM and then compared to that of which the software subscribing insurance producer has access to. This comparison of premium rates (or LCMs) is integrated and results exposed on a computer, electronic tablet device such as an Ipad™ and or other computer device. This information ay include the spread between the expiring company's price and the potential offering of the insurance producer through their insurance company on an electronic computer tablet or other electronic computing device, as at step 3. For example if the current (expiring) carriers LCM is a 1.62 and the potential offering for a similar risk with the producer's insurance company is 1.05, then this information will be exposed on the electronic computer device to allow the insurance producer that they may have a potential better offer than what the prospect currently has on the expiring policy. The computer device may illustrate something like Table 2 as follows:

TABLE 2
Premium Comparison for ABC Company, LLC

| Current | Proposed |
|---|---|
| Policy | Policy |
| Rate | Rate |
| $22.50 | $14.62 |

Savings Percent 34%

Data from the database may be prefilled into an application set typically used for workers compensation to either issue a policy or start the quote process. The application most often used or commonly used for this process is an ACORD™ application. Those questions needed to complete the balance of the workers compensation application are exposed and available for the producer to complete. Additionally, the information may bridge/transfer or by other means integrate into the agency management system or insurance carrier's rating or policy issuance system/underwriting system for evaluation, consideration or policy issuance. The integration of the prior policy records are also important and very germane to this patent application because part of the application process is identifying who the prior carriers are and the expiring carrier as the insurance companies considering the potential of insuring a business wants to know that the prospect (potential insured) has had prior coverage and the insurance producer's job is to identify who these prior carriers are, as at step 4. The Database of Information may covert into an application such as an ACORD application and may appear like the Table 3 below:

TABLE 3
Information assimilated from prior policies may
convert into an application as follows
PRIOR CARRIER INFORMATION/LOSS HISTORY -Provide
Information for the past 5 years and use the remarks section for loss details

| | | |
|---|---|---|
| Year | Carrier & Policy Number | Annual Premium |

Co* STATE FARM MUTUAL
Pol # WC - 1234567894
Co * STATE FARM MUTUAL
Pol # WC-1234567893
Co* STATE FARM MUTUAL
Pol #WC- 1234567892
Co * STATE FARM MUTUAL
Pol # WC-1234567891
Co* STATE FARM MUTUAL
Pol # WC - 1234567890

A document/letter to assimilate requesting loss runs (loss history reports) from current and prior carriers may be prefilled for each policy, both current and expired policies on the computer, tablet computer or other device. Once the documents are prefilled, a location on the computer is available for the policyholder or their representatives to sign using an electronic pen or other device, or may be printed and signed manually, faxed, or emailed to the prospect. Regardless of the exact method, the germane portion of the patent is that the document is prefilled with either the current or expired policy records of prior carrier name, address, and other important items which may include policy number, etc. The process also allows for the insurance producer the ability to assimilate a letter to the rating bureaus such as NCCI to allow the insurance producer or his/her staff the authority to obtain information such Experience Modifications, etc. These documents may also be signed electronically or manually as described above. The process may also allow for the insurance producer the ability to assimilate and obtain signatures on documents titled “agent of record” or “broker of record.” These documents may also be signed electronically or signed manually. An additional step in the process involves notifying the prospect as to what to expect next. This may be an electronic notification or paper document assimilation or fax or email instructing the prospect what to expect next or what the process may involve moving forward, as at step 5.

Prospective customers may decide to expose their insurance information and manage the process of shopping or managing the insurance policy with the same data and expose the information and the fact they wish to discuss their insurance policies, or that they are “open to bid” the coverage, as at step 5b.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A method of approaching insurance prospects of an insurance agent for sale of insurance products comprising the steps of:
accessing a database limited to insurance information of entities, said database having entries having at least an expiration date of an insurance policy and an address of the insured;
searching the database for policies that meet criteria as identified entities; and then
displaying a map showing the location of the identified entities to an electronic computer device.

2. The method of claim 1 wherein the step of displaying the map also plots a current location of the computer device on the map.

3. The method of claim 2 wherein the computer device has a built in GPS device.

4. The method of claim 1 wherein the entries in the database further comprises at least one of LCM and pricing, and the step of searching the database further comprises comparing the at least one of LCM and pricing to offerings of the insurance agent, and if the offerings of the insurance agent relative to the entries are more competitive for a selected entry, said selected entry becoming an identified entry.

5. The method of claim 1 wherein the database is comprised of workers compensation insurance entries.

6. The method of claim 1 wherein the step of accessing must be preceded by a step of subscribing to a service to map the identified entities.

7. The method of claim 3 further comprising the step of tracking the position of the computer device relative to the identified entities as agent data and exporting the agent data to a monitor remote to the computer device.

8. The method of claim 1 wherein the database further comprises entity information and the entity information is uploaded into at least one of a form, application and a letter by the computer device for use by the insurance agent to at least assist in providing a quote to a representative of the identified entity.

9. The method of claim 8 wherein the representative is provided with an opportunity to sign at least one of the application and the letter with a signature on the computer device in an effort to at least one of apply for a policy, initiate a policy and write a letter to an existing insurance company requesting information.

10. The method of claim 1 wherein at least some information obtained from identified entities is uploaded into at least one of a customer relationships management program (CRM), policy administration system (PAS) and agency management system (AMS).

11. The method of claim 8 wherein the representative requests a loss records run from the existing insurance company.

12. The method of claim 1 wherein a tag is placed on the location of the identified entity on the map and a bubble is provided with information about the entity relative to the tag.

13. A method of approaching insurance prospects of an insurance agent for sale of insurance products comprising the steps of: accessing a database including insurance information of entities, said database having entries having at least one of pricing, an LCM, and information sufficient to calculate and LCM of an insurance policy and an address of the insured;
searching the database for policies that meet criteria relative to at least one of LCM and pricing as identified entities; and then
displaying a map showing the location of the identified entities to an electronic computer device.

14. The method of claim 13 wherein the database further comprises entity information and the entity information is uploaded into at least one of a form, application and a letter by the computer device for use by the insurance agent to at least assist in providing a quote to a representative of the identified entity.

15. The method of claim 14 wherein the representative is provided with an opportunity to sign at least one of the application and the letter with a signature on the computer device in an effort to at least one of apply for a policy, initiate a policy and write a letter to an existing insurance company requesting information.

16. The method of claim 13 further comprising comparing the at least one of LCM and pricing to offerings of the insurance agent, and if the offerings of the insurance agent relative to the entries are more competitive for a selected entry, said selected entry becoming an identified entry.

17. The method of claim 13 wherein the database further comprises entity information and the entity information is uploaded into at least one of a form, application and a letter by the computer device for use by the insurance agent to at least assist in providing a quote to a representative of the identified entity.

18. A method of approaching insurance prospects of an insurance agent for sale of insurance products comprising the steps of:
accessing a database including insurance information of entities, said database having entries having data of an insurance policy including an address of the insured;
searching the database for policies that meet criteria as identified entities; and then
displaying a map showing the location of the identified entities to an electronic computer device; and then
outputting at least some of the data to at least one of a form, application and a letter by the computer device for use by the insurance agent to at least assist in providing a quote to a representative of the identified entity.

19. The method of claim 18 wherein the representative is provided with an opportunity to sign at least one of the application and the letter with a signature on the computer device in an effort to at least one of apply for a policy, initiate a policy and write a letter to an existing insurance company requesting information.

20. The method of claim 18 wherein the entries further comprise at least one of pricing, an LCM, and information sufficient to calculate and LCM of an insurance policy and the search step compares to see if the offerings of the insurance agent relative to the entries are more competitive for a selected entry, said selected entry becoming an identified entry.
